(19) United States
(12) Patent Application Publication
(10) Pub. No.: US 2024/0151274 A1
(43) Pub. Date: May 9, 2024

(54) POWER DRIVE UNIT DRIVESHAFT WITH WOBBLE CONNECTION

(71) Applicant: Brose Fahrzeugteile SE & Co. Kommanditgesellschaft, Bamberg, Bamberg (DE)

(72) Inventors: Shane Alexander, Ortonville, MI (US); Michael Kidd, Oxford, MI (US); Andrew Lakerdas, London (CA)

(73) Assignee: Brose Fahrzeugteile SE & Co. Kommanditgesellschaft, Bamberg, Bamberg (DE)

(21) Appl. No.: 17/980,750

(22) Filed: Nov. 4, 2022

(51) Int. Cl. F16D 3/20; E05F 15/611

(52) U.S. Cl. CPC F16D 3/20; E05F 15/611; E05Y 2201/706; E05Y 2900/542

(57) ABSTRACT

A drive system for a vehicle closure includes a drive unit having a first coupler supported for rotation about a first longitudinal axis. The first coupler defines a receptacle. A second coupler has a first side and a second side configured to engage with a hinge component of a vehicle. A driveshaft extends between the first and second couplers at an angled orientation relative to the first and second axes. The driveshaft has a first end connected to the first coupler and a second end connected to the first side of the second coupler.

### TECHNICAL FIELD

The present disclosure relates to powered vehicle closures and more specifically drive systems for opening and closing the closure.

### BACKGROUND

Vehicles may include one or more closures, such as, hatches, doors, tailgates, liftgates. Certain closures are powered to close automatically. Vehicles generally include a seal or other type of weather proofing barrier positioned between the closure and the vehicle body to mitigate external elements such as moisture, precipitation, dirt, debris, and noise from entering the interior of the vehicle.

### SUMMARY

According to one embodiment, a drive system for a vehicle closure includes a drive unit having a first coupler supported for rotation about a first longitudinal axis. The first coupler defines a receptacle. A second coupler has a first side and a second side configured to engage with a hinge component of a vehicle and is supported for a rotation about a second longitudinal axis that is parallel to and offset from the first axis. A driveshaft extends between the first and second couplers at an angled orientation relative to the first and second axes. The driveshaft has a first end connected to the first coupler and a second end connected to the first side of the second coupler. The first end defines a plurality of engaging surfaces that are arcuate in a direction parallel to a third longitudinal axis of the driveshaft and are circumferentially arranged around the third axis such that the engaging surfaces are joined to each other at edges that are arcuate in the direction parallel to the third axis, wherein the first end is received in the receptacle of the first coupler with the engaging surfaces disposed against sides of the receptacle such that the engaging surfaces are configured rock on the sides to permit an angle between the driveshaft and first coupler.

According to another embodiment, a drive system for a vehicle closure includes a drive unit having a motor operatable connected to a coupler with a first longitudinal axis. The coupler defines a polygon-shaped receptacle having a plurality of sides arrayed around the first longitudinal axis and circumferentially interconnected to form a plurality of inside corners extending parallel to the first axis. A driveshaft has a second longitudinal axis that is angled relative to the first longitudinal axis. The driveshaft includes a central portion and a first ball end arranged along the second longitudinal axis. The first ball end has a tip, a neck joined to the central portion, and defines a plurality of engaging surfaces that are arcuate in a direction parallel to the second longitudinal axis and are circumferentially arranged around the second axis such that the engaging surfaces are joined to each other at arcuate edges that extend between the neck and the tip. Wherein, the first ball end is received in the receptacle with the engaging surfaces disposed against the sides and the arcuate edges received in the inside corners to rotationally fix the driveshaft to the coupler, and wherein each of the engaging surface includes at least a first portion and a second portion that are longitudinal spaced from each other such that, when the driveshaft is in a first angled position relative to the first longitudinal axis, the first portion is in contact with a corresponding one of the sides while the second portion is not in contact with the corresponding side.

According to yet another embodiment, a vehicle closure system includes a vehicle closure pivotally attachable to a vehicle body, the closure including panels defining an interior. A first coupler is supported in one of the panels of the closure for rotation about a first axis. A brace is disposed in the interior such that the first axis extends through the brace. A drive system is configured to pivot the closure relative to the vehicle body and is disposed in the interior. The drive system has a motor and a second coupler operably coupled to the motor. The second coupler is supported for rotation about a second axis that is parallel to and vertically offset from the first axis such that the second axis does not extend through the brace. A driveshaft is angled to extend between the first and second axes and having a first end wobbably connected to the first coupler and a second end wobbably connected to the second coupler.

### BRIEF DESCRIPTION OF THE DRAWINGS

FIG. 1 is a rear perspective view of a portion of a pickup truck.

FIG. 2 is a perspective view of the closure with a back panel removed to illustrate internal components including a drive system of the closure.

FIG. 3 is a perspective view of a driveshaft of the drive system.

FIG. 4 is a perspective view of a first end of the driveshaft.

FIG. 5 is a cross-sectional view at connection of the coupler to the driveshaft.

FIG. 6 illustrates a side view of the driveshaft connected to the couplers at a first orientation.

FIG. 7 illustrates a side view of the driveshaft connected a coupler at a second orientation.

FIG. 8 is a side view of a connection including a retaining member.

FIG. 9 is a perspective view of a retaining member.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Vehicles include many different components that are movable relative to each other. For example, a vehicle includes body and a variety of closures such as doors, tailgates, liftgates, etc. depending on the type of vehicle. One or more of these closures may be automatically opened, closed, or both. A latch is used to secure the closure closed. A seal is typically provided on the body, the closure, or both to seal the cabin from the elements. A closure may be described as having an open position, a partially closed position in which the latch is in contact with a striker of the closure and the closure is resting on the seal, and a fully closed position in which the latch is locked and the seal is compressed. This disclosure presents a drive-system capable of pivoting a vehicle closure, e.g., a tailgate.

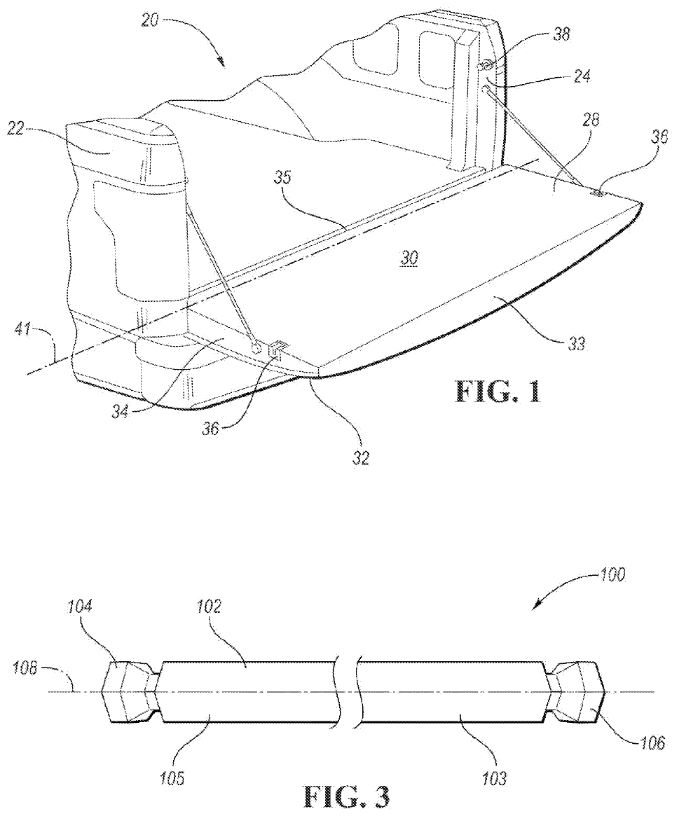

Referring to FIG. 1, a vehicle 20, such as a pickup truck, includes a body 22 and a closure 28 that is movably attached to the body 22 so that the closure can open and close. The closure may be a tailgate, a door, a hatch, a truck lid, a hood, or the like. In one example, the closure 28 is a tailgate pivotally attached to sidewalls 24 at a rear end of a box. In this embodiment, the tailgate 28 includes an inner panel 30, an outer panel 32, a pair of lateral side panels 34, a top panel 33, and a bottom panel 35. In some embodiments, the lateral sides 34, top panel 33, and/or bottom panel 35 are integrally formed with the inner panel or the outer panel, and are secured to the other of the inner and outer panels by hemming or by another type of connection. Each of the lateral sides 34 includes a connection feature, e.g., a post, that is engageable with a corresponding connection feature, e.g., a socket, on one of the sidewalls 24. These post and sockets, for example, define a hinge of the tailgate that has a pivot axis 41 extending therethrough. The tailgate 28 pivots open and a closed along the connection features. Each lateral side 34 may support a latch 36 that cooperates with a corresponding striker 38 connected to one of the sidewalls 24. The latch 36 and the striker 38 secure the tailgate 28 closed. The tailgate 28 also includes a handle operably connected to the latches 36 and configured to disengage the latches 36 from the strikers 38 to open the tailgate 28. The vehicle may also be able to open the latches 36 remotely with the press of a button or the like. The latches 36 may include a lock operable by a key, a button, a key fob, etc. When locked, the tailgate 28 cannot be opened.

As will be described in more detail below, the closure 28 is configured to automatically open and/or close. The closure may include an actuator, such as an electric motor, that pivots the closure between the open and closed positions. The vehicle may include an input, e.g., a button, located within the passenger cabin, on a key fob, etc., that when pressed, commands actuation of the closure.

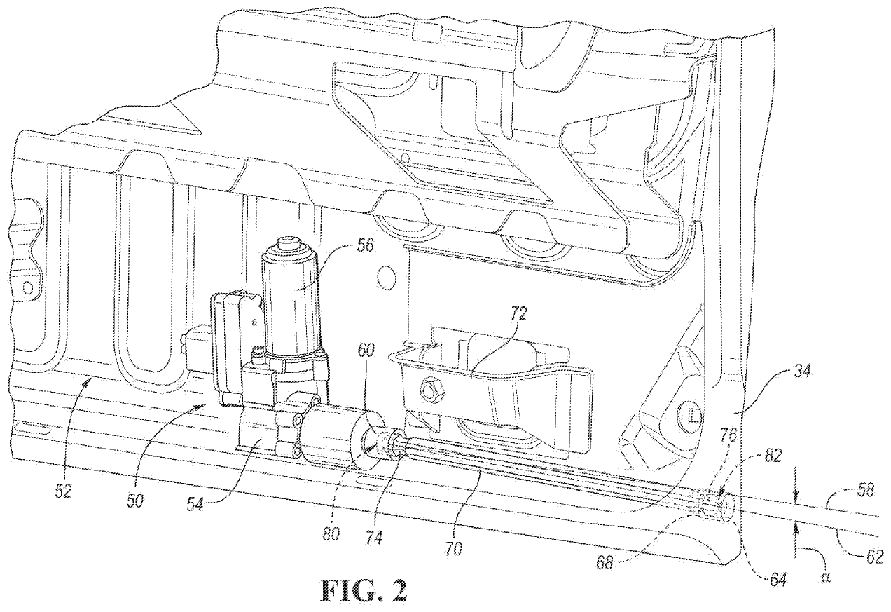

Referring to FIG. 2, the closure system will be described in a tailgate application, but it is to be understood that this is just an example; the closure system may be used in other applications such a door, a rear hatch, a trunk lid, a hood, etc. The closure 28, e.g., a tailgate, includes a drive unit 50 for closing the tailgate 28 disposed within an interior 52 of the closure 28. The drive unit includes a housing 54 that may support at components of a gearing arrangement or the like. The housing may be attached to the bottom panel 35 by fasteners or the like. The drive unit 50 includes an actuator 56 such as an electric motor. In the illustrated embodiment, the electric motor 56 is arranged vertically with an output of the motor being coupled to a gearing arrangement that transfers the vertical axis of the motor into a horizontal axis 58. The drive unit 50 further includes a coupler 60 supported for rotation about the axis 58. The coupler 60 is operably coupled to the motor 56 via the gearing arrangement or the like. The coupler 60 is the output of the drive unit 50.

A second coupler 64 is disposed in the sidewall 34 and may be supported by a bearing. The second coupler 64 is supported for rotation about a second axis 62 that is parallel to an offset from the axis 58 by a distance or offset (0). The coupler 64 is configured to engage with a component that is rotationally fixed to the body 22 of the vehicle. For example, the coupler includes a first side 66 that connects to the component of the vehicle 20 in a manner known in the art. A second side 68 of the coupler 64 provides a connection for a driveshaft 70 that extends between the coupler 60 and 68 to operably couple the coupler 68 to the actuator 56. The driveshaft 70 may include a first end 74 operably coupled to the coupler 60 and a second end 76 operably coupled to the coupler 64.

The driveshaft 70 is angled to avoid the bracket 72. Due to the size of the drive unit 50, the output axis 58 extends through the bracket 72. Thus, in order to connect with the coupler 64, which is on the opposite side of the bracket 72, the driveshaft 70 has to angle downwardly from the first coupler 60 to the second coupler 64. The driveshaft 70 must be rotationally fixed to both couplers 60 and 64 in order to pivot the closure 28. Normally, a spline connection is used. However, that is not possible in this design due to the angle of the driveshaft. To accommodate this angle, at least one of the couplers, and in the illustrated embodiment both of the couplers, have a wobble connection between the coupler and end of the driveshaft. The wobble connection provides the necessary rotational fixing while allowing an angle between the driveshaft and the axes of rotation 58 and 62.

The coupler 60 may define a receptacle 80 that receives the end 74 therein and the coupler 64 may define a receptacle 82 that receives the end 76 therein. The receptacles and the ends may be sized and shaped to form the wobble connection(s). The wobble connections may be configured as constant velocity connections in which the coupler and the driveshaft have a same velocity is each other.

In the above closure 28, the driveshaft is grounded to the vehicle by the coupler 64 and does not rotate. Instead, the housing 54 and the actuator 56 rotate with the closure about the axis 58 to pivot the closure 28 open and close. That is, the driveshaft is fixed to the vehicle and the actuator is fixed to the closure.

The following figures and associated text describe examples of the driveshaft 70 and the couplers 60, 64.

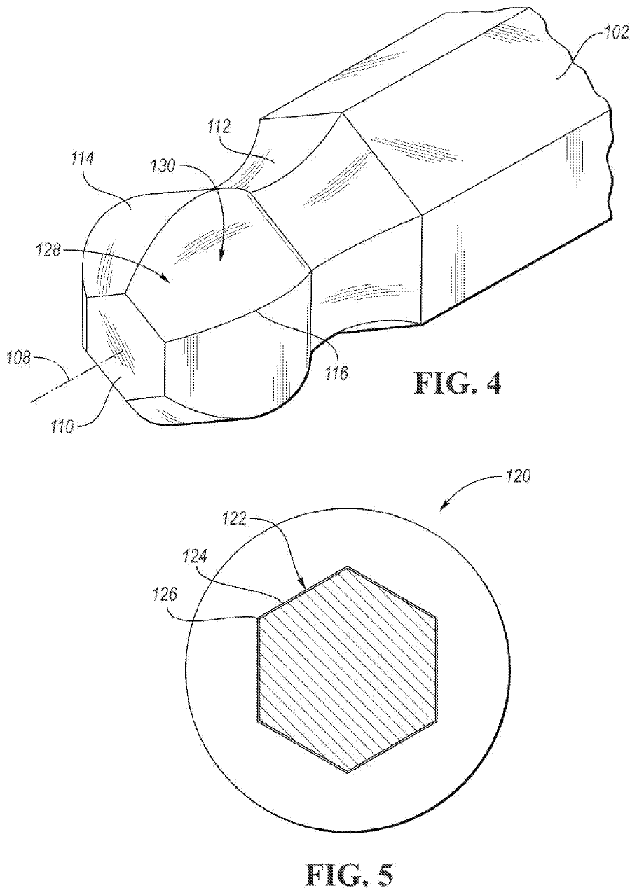

Referring to FIGS. 3 and 4, a driveshaft 100 is one example embodiment of the driveshaft for the drive system. The driveshaft includes a central portion 102, a first ball end 104 and a second ball end 106. The ends and the central portion may be integrally formed, such as machined from a common bar stock. The first and second ball ends are configured to form the wobble connection with the couplers. The driveshaft 100 has a longitudinal axis or centerline 108. The central portion 102 may have six sides 103 interconnected at six longitudinal edges 105 and a hexagonal cross-section.

The first ball end 104 has a tip 110 and a neck 112 joined to the central portion 102. The first end 104 defines a plurality of engaging surfaces 114 that are arcuate in a direction parallel to the longitudinal axis 108 and are circumferentially arranged around the axis 108 such that the engaging surfaces 114 are joined to each other at arcuate edges 116 that extend between the neck and the tip. The number of engaging surfaces 114 and arcuate edges 116 may match the sides 103 and edges 105 of the central portion. In the illustrated embodiment, the first end 104 has six engaging surfaces 114 and six arcuate edges 116. The engaging surfaces 114 are circumferentially aligned with the sides 103 and the arcuate edges 116 are circumferentially aligned with the edges 105. The second end 106 may be the same as the first end 104 and will not be explained again for brevity. The receptacles of both couplers may also be the same.

FIG. 5 illustrates a wobble connection 120 between the coupler 60 and the first end 104 according to one or more embodiments. In this example, the coupler 60 defines a polygon-shaped receptacle 122 having a plurality of sides 124 arrayed around a longitudinal axis of the coupler 60, which is coaxial with the axis 58. The sides 124 are circumferentially interconnected to form a plurality of inside corners 126 extending parallel to the axis 58. In this embodiment, the receptacle 122 has six sides and six inside corners to match the six sides of the driveshaft 100. The receptacle 122 is sized substantially the same as the first end 104 albeit slightly larger to accommodate assembly. While the illustrated embodiment includes six sides, the number of sides for the driveshaft, ends, and receptacles may be more or less in other embodiments.

The first ball end 104 is received in the receptacle 122 with the engaging surfaces 114 disposed against the sides 124 and the arcuate edges 116 received in the inside corners 126 to rotationally fix the driveshaft 100 to the coupler 60 while permitting and angle between the receptacle 122 and the ball end 104 of driveshaft.

Referring to FIGS. 4, 6, and 7, the arcuate shape of the engaging surfaces 114 and the edges 116 allow the ball end 104 to tilt or rock within the receptacle resulting in only a portion of each the engaging surfaces being engaged with the corresponding side 124 at any one time. For example, each of the engaging surface 144 includes at least a forward-most portion 128, rear-most second portion 130, and a plurality (which may be an infinite number) of intermediate portions therebetween. These portions are arranged along the longitudinal axis 108 with the forward portion 128 and the rear portion 130 being longitudinal spaced from each other.

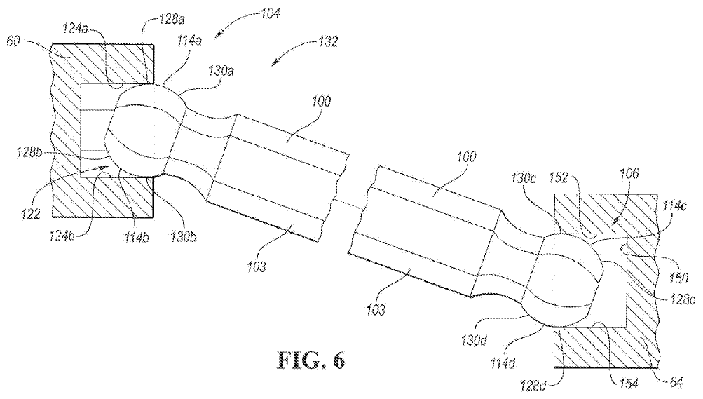

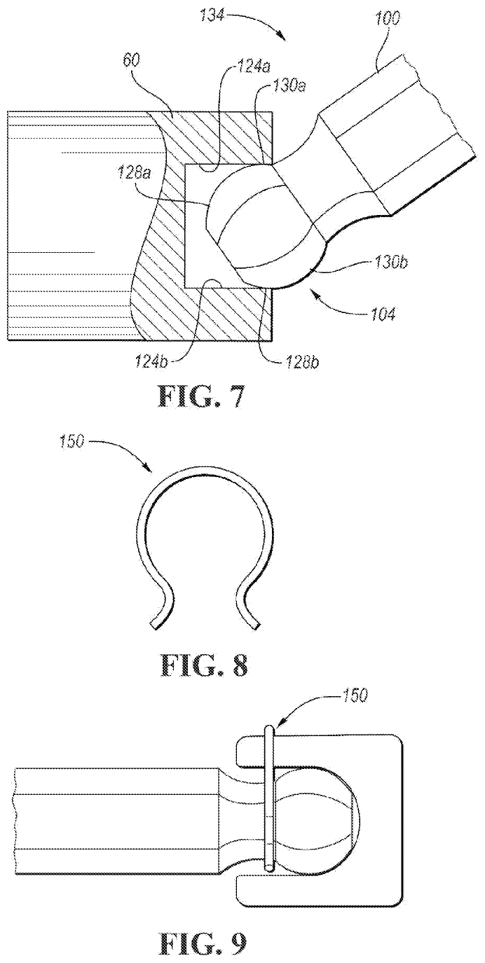

FIGS. 6 and 7 illustrate how the driveshaft may be angled relative to the coupler and how the ball end moves with the receptacle to achieve these different angled orientations of the driveshaft. As will be explained in more detail below, the arcuate nature of the engaging surfaces 114 and the edges 116 allow for the ball end 104 rock or tilt relative to the sides 124 of the receptacle to permit angling of the driveshaft.

FIG. 6 illustrates the coupler 60 and driveshaft 100 in a first position 132. As can be seen, the driveshaft 100 is angled downwardly and the ball end 104 is tilted within the receptacle 122. For illustrative purposes, the driveshaft is shown in the most downward tilted position. It is to be understood, however, that the offset between the axes 58 and 62 may not require such an extreme angle of the driveshaft. (In this illustration, the sides 124a and 124b are diametrically opposed as are the engaging surfaces 114a and 114b.) In the first position 132, the forward-most portion 128a is engaged with the side 124a while the rearmost portion 130a is disengaged. At the bottom of the connection, the rear-most portion 130b is engaged with the side 124b while the forward-most portion 128 is disengaged.

FIG. 7 illustrates the coupler and the driveshaft 100 and a second position 134 in which the driveshaft is now angled upwardly from the coupler 60. For illustrative purposes, the driveshaft is shown in the most upwardly tilted position. Here, the forward-most portion 128a is now disengaged and the rear-most portion 130a is engaged with the side 124a. The forward-most portion 128b is now engaged with the side 124b while the rear-most portion 128 is disengaged. During the transition between positions 132 and 134, the arcuate engaging surfaces 114 have rocked on the sides 124 via the arcuate surface of the engaging surfaces 114 and edges 116.

Referring back to FIG. 6, the second coupler 64 defines a receptacle 150, which may be the same as receptacle 122. The receptacle 150 includes a first side 152 and a second side 154 that are diametrically opposed. The second end 106, which may be the same as the first end 104, has engaging surfaces 114c and 114d that are diametrically opposed. Due to the angle of the driveshaft 100, the rear-most portion 130c is engaged with the side 124c while the forward-most portion 128a is disengaged, and the forward-most portion 128d is engaged with the side 124d while the rear-most portion 130d is disengaged.

Referring to FIGS. 8 and 9, one or more retainers 150 (optional) may be provided to secure the one or more ends to the one or more couplers. For example, a first retainer 150 is connected between the first end 104 and the coupler 60 to retain the first end in the receptacle 122.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A drive system for a vehicle closure comprising:
drive unit including a motor operatable connected to a coupler having a first longitudinal axis, the coupler defining a polygon-shaped receptacle having a plurality of sides arrayed around the first longitudinal axis and circumferentially interconnected to form a plurality of inside corners extending parallel to the first axis;
a driveshaft having a second longitudinal axis that is angled relative to the first longitudinal axis, the driveshaft including a central portion and a first ball end arranged along the second longitudinal axis, the first ball end having a tip, a neck joined to the central portion, and defining a plurality of engaging surfaces that are arcuate in a direction parallel to the second longitudinal axis and are circumferentially arranged around the second axis such that the engaging surfaces are joined to each other at arcuate edges that extend between the neck and the tip; wherein
the first ball end is received in the receptacle with the engaging surfaces disposed against the sides and the arcuate edges received in the inside corners to rotationally fix the driveshaft to the coupler, and
each of the engaging surface includes at least a first portion and a second portion that are longitudinal spaced from each other such that, when the driveshaft is in a first angled position relative to the first longitudinal axis, the first portion is in contact with a corresponding one of the sides while the second portion is not in contact with the corresponding side.

2. The drive system of claim 1, wherein, when the driveshaft is in a second angled position relative to the first longitudinal axis, the second portion is in contact with the corresponding side while the first portion is not in contact with corresponding side.

3. The drive system of claim 1 further comprising a retainer connected between the first end and the coupler to retain the first ball in the receptacle.

4. The drive system of claim 3, wherein the retainer is a C-clip.

5. The drive system of claim 1, wherein the sides of the receptacle are in equal number to the engaging surfaces of the first ball end.

6. The drive system of claim 5, wherein the receptacle includes six sides.

7. The drive system of claim 1 further comprising:
a second ball end formed on the driveshaft opposite the first ball end and arranged on the second longitudinal axis; and
a second coupler connected to the second ball end, wherein the second coupler has a third longitudinal axis that is parallel to and offset from the first longitudinal axis and the driveshaft is angled to extend between the coupler and the second coupler.

8. The drive system of claim 7, wherein the second coupler defines a second polygon-shaped receptacle having a plurality of second sides arrayed around the third longitudinal axis and circumferentially interconnected to form a plurality of second inside corners extending parallel to the third axis, wherein the second ball is received in the second receptacle with the engaging surfaces of the second ball disposed against the second sides and the arcuate edges received in the second inside corners to rotationally fix the driveshaft to the second coupler.

9. The drive system of claim 8, wherein each of the engaging surface of the second ball includes at least a first portion and a second portion that are longitudinal spaced from each other such that, when the driveshaft is in the first position, the first portion is in contact with a corresponding one of the second sides while the second portion is not in contact with the corresponding second side.

10. The drive system of claim 1, wherein the coupler and driveshaft are rotationally fixed to have a constant velocity therebetween.

11. A drive system for a vehicle closure comprising:
drive unit including a first coupler supported for rotation about a first longitudinal axis, the first coupler defining a receptacle;
a second coupler including a first side and a second side configured to engage with a hinge component of a vehicle, the second coupler supported for a rotation about a second longitudinal axis that is parallel to and offset from the first axis; and
a driveshaft extending between the first and second couplers at an angled orientation relative to the first and second axes, the driveshaft including a first end connected to the first coupler and a second end connected to the first side of the second coupler, the first end defining a plurality of engaging surfaces that are arcuate in a direction parallel to a third longitudinal axis of the driveshaft and are circumferentially arranged around the third axis such that the engaging surfaces are joined to each other at edges that are arcuate in the direction parallel to the third axis, wherein the first end is received in the receptacle of the first coupler with the engaging surfaces disposed against sides of the receptacle such that the engaging surfaces are configured rock on the sides to permit an angle between the driveshaft and first coupler.

12. The drive system of claim 10, wherein the first side of the second coupler defines a second receptacle, and wherein the second end of the driveshaft defines a plurality of second engaging surfaces that are arcuate in the direction parallel to the third longitudinal axis of the driveshaft and are circumferentially arranged around the third axis such that the second engaging surfaces are joined to each other at second edges that are arcuate in the direction parallel to the third axis, wherein the second end is received in the second receptacle of the second coupler with the second engaging surfaces disposed against second sides of the second receptacle such that the second engaging surfaces rock on the second sides as the driveshaft and second coupler rotate allowing angled orientations of the driveshaft.

13. The drive system of claim 11 further comprising a retainer connected between the first end and the first coupler to retain the first end in the receptacle.

14. The drive system of claim 13, wherein the retainer is a C-clip.

15. The drive system of claim 13 further comprising a second retainer connected between the second end and the second coupler.

16. The drive system of claim 15, wherein the second retainer is a C-clip.

17. The drive system of claim 11, wherein the sides of the receptacle are in equal number to the engaging surfaces of the first end.

18. A vehicle closure system comprising:
a vehicle closure pivotally attachable to a vehicle body, the closure including panels defining an interior;
a first coupler supported in one of the panels of the closure for rotation about a first axis;
a brace disposed in the interior such that the first axis extends through the brace;
a drive system configured to pivot the closure relative to the vehicle body and disposed in the interior, the drive system including a motor and a second coupler operably coupled to the motor, the second coupler being supported for rotation about a second axis that is parallel to and vertically offset from the first axis such that the second axis does not extend through the brace; and
a driveshaft angled to extend between the first and second axes and having a first end wobbably connected to the first coupler and a second end wobbably connected to the second coupler.

19. The vehicle closure of claim 18, wherein the drive system includes a housing attached to a bottom one of the panels

20. The vehicle closure of claim 18, wherein the second coupler defines a polygon-shaped receptacle having a plurality of sides arrayed around the second axis and circumferentially interconnected to form a plurality of inside corners extending parallel to the second axis, wherein the second end of the driver shaft has a tip and a neck joined to a central portion of the driveshaft, the second end defining a plurality of engaging surfaces that are arcuate in a direction parallel to a longitudinal axis of the driveshaft and are circumferentially arranged around the longitudinal axis such that the engaging surfaces are joined to each other at arcuate edges that extend between the neck and the tip, wherein the second ball end is received in the receptacle with the engaging surfaces disposed against the sides and the arcuate edges received in the inside corners to wobbably connect the driveshaft to the second coupler in a rotationally fixed manner, and wherein each of the engaging surface includes at least a first portion and a second portion that are longitudinal spaced from each other such that, when the driveshaft is in a first position, the first portion is in contact with a corresponding one of the sides while the second portion is not in contact with the corresponding side.
